(19) United States
(12) Patent Application Publication
(10) Pub. No.: US 2006/0240157 A1
(43) Pub. Date: Oct. 26, 2006

(54) Garlic vodka

(76) Inventors: Anna Denysyk, Morris Plains, NJ (US); Oleh Denysyk, Morris Plains, NJ (US)

Correspondence Address: ANNA & OLEH DENYSYK, P.O. BOX 777, MORRIS PLAINS, NJ, 07950, US

(21) Appl. No.: 11/029,979

(22) Filed: Apr. 21, 2005

(51) Int. Cl. C08G 59/42

(52) U.S. Cl. 426/131

(57) ABSTRACT

Garlic Vodka is vodka with garlic, consisting of fresh garlic cloves, peeled and chopped, mixed with any proof vodka. Garlic Vodka is stored in a glass bottle because the scent of garlic permeates plastic bottles, and it is stored at room temperature. Garlic Vodka is an unusual combination that we've made for years, and serving Garlic Vodka always elicits pleasant surprise from those sipping it for the first time—usually requesting a second taste. This is a novelty alcoholic beverage, delivering the healthy beneficial components of garlic. Garlic Vodka is a delicious ingredient in cooking, for example, as an ingredient in Penne with Vodka Sauce and Shrimp Scampi. While camping outdoors, in the woods, we also discovered an interesting and completely unexpected aspect of Garlic Vodka while camping: the morning after drinking a small amount of Garlic Vodka, we discovered that the mosquitoes and insects did not bite or land on our skin, as they did the previous evening/night; the scent of garlic was still coming out of our skin pores and repelling insects!

Vodka with garlic: consisting of one head (+/−) of fresh garlic cloves, peeled and chopped, and mixed with (+/−) 750 ml vodka (any proof); stored in a glass bottle, room temperature, and served as an alcoholic beverage or cooking ingredient. Above are sample proportions based upon desired liquid amount.

Garlic vodka is an unusual combination that we've been making for years, and makes for a savory alcoholic beverage, and also a tasty cooking ingredient: for example, in the vodka/tomato sauce for Penne with Vodka Sauce.

1. We claim that our invention is “Garlic Vodka”, also known as vodka with garlic: Consisting of one head (+/−) of fresh garlic cloves, peeled and chopped, and mixed With (+/−) 750 ml vodka (any proof), stored in a glass bottle, room temperature. Garlic Vodka is served as an alcoholic beverage and/or cooking ingredient. Above are sample proportions based upon desired liquid amount.
